(19) United States
(12) Patent Application Publication
(10) Pub. No.: US 2015/0298883 A1
(43) Pub. Date: Oct. 22, 2015

(54) CONTAINER WITH SCOOP TRAY

(71) Applicant: Alexander Josephus Maricus Van Puijenbroek, Den Bosch (NL)

(72) Inventor: Alexander Josephus Maricus Van Puijenbroek, Den Bosch (NL)

(21) Appl. No.: 14/411,232

(22) PCT Filed: Jun. 27, 2012
(86) PCT No.: PCT/NL2012/050454

§ 371 Date: May 11, 2015

(51) Int. Cl. B65D 77/24; A23L 1/29; A23L 2/39; B65D 83/06

(52) U.S. Cl. CPC B65D 77/245; B65D 83/06; A23L 1/296; A23L 2/39; A23V 2002/00

(57) ABSTRACT

A package for a powdered nutritional product includes a container defining a powder compartment for receiving the nutritional product, having a base and a peripheral wall. A scoop tray defining a scoop recess containing an elongate scoop is provided within the container. A circumferential rim for connection to the container defines a wide access opening. A lid is hingedly attached to the rim for reclosing the access opening and covering the scoop tray. The powder and scoop are sealed at their respective locations by at least one foil arranged to seal the container prior to use by independently sealing the powder compartment and the scoop tray.

### BACKGROUND OF THE INVENTION

1. Field of the Invention

The present invention relates to containers for the packaging of powder products, in particular for infant nutrition such as powdered or granulated milk formula. The invention further relates to a package comprising the combination of a container containing a quantity of product and a measuring scoop in a scoop tray.

2. Description of the Related Art

Infant milk formula has been sold in various forms of package for many years. Metal cans were initially the preferred container as they were relatively easy and cheap to produce and could be sealed for long term storage. The seal comprised an aluminium foil across the mouth of the container that was removed on first use. As a single container would be used for an extended period, the containers were provided with resealable plastic lids which gripped over the outer rim of the can. A measuring scoop was frequently included with the container, either packaged separately or within the can itself. Compared with modern materials, such cans are now considered relatively expensive and heavy. The inclusion of a scoop within the package itself on purchase is also less desirable since it inevitably is buried during transport and the user, on first opening the package must bury in the content to retrieve the scoop.

More recently, alternative packaging forms have become available which improve on the existing cans. These include plastic and foil laminate container bodies and hinged lid assemblies having a facility to receive and retain a measuring scoop. One such package is described in US 2008041861, the contents of which are hereby incorporated by reference in their entirety. That package has a seal for initially closing the package and a space between the seal and an upper edge of the container for partially receiving the scoop prior to use. An elevation or cavity is also provided in the container lid and once the container is opened, the scoop may be retained at least partially within the lid.

The relative sizes of the space and the cavity depend upon the form of the lid construction and the size of the scoop. These in turn are related to the stacking characteristics of the package, which is designed to stack with other similar packages e.g. on supermarket shelving.

Further similar packages are shown in US2010236966 and WO2010071424, the contents of both of which are hereby incorporated by reference in their entirety. The above described packages have comprised generally upright containers i.e. having a height greater than a width or breadth. More recently, lid designs have attempted to provide a relatively large access opening to the container interior so that a user may easily remove all of the contents with the scoop provided. A large lid opening however imposes limitations on the lid construction if adequate sealing is to be achieved. Increasing the width of the container with respect to the height can also lead to significant dead volume. A fixed height head space is required within the container to locate the scoop above the product. A wider but shorter container would have relatively more dead volume.

Additionally, the position of the scoop within the lid cavity has been found inconvenient by some users. Instead, the scoop is merely dropped back into the container where it may become buried within the powder.

It would therefore be desirable to provide an alternative container construction that alleviated at least some of the perceived inconveniences of the prior art.

### BRIEF SUMMARY OF THE INVENTION

According to the invention there is provided a package for a powdered nutritional product comprising a container defining a powder compartment for receiving the nutritional product, the container having a base and a peripheral wall, a circumferential rim for connection to the container and defining a wide access opening, a scoop tray for storing an elongate scoop, a scoop contained in the recess, a lid, hingedly attached to the rim for reclosing the access opening and covering the scoop tray, and at least one foil arranged to seal the container prior to use by independently sealing the powder compartment and the scoop tray. By providing a scoop tray and a scoop in this manner, the scoop may be simply placed into the recess after use. Furthermore, by independently sealing the powder compartment and the scoop tray prior to use by at least one foil it is prevented that the contents of the container can enter the scoop tray and the scoop held within the scoop tray, thereby securing a clean scoop prior to use and avoiding the need to bury within the contents. Advantageously, because the scoop is contained beneath the foil, it may be provided to the package prior to sealing and will not become lost. This is of significance if the rim and lid are applied at a later stage.

The lid is intended to reclose the access opening to prevent escape of product from the powder compartment once the foil has been removed after first use. It should also prevent ingress of moisture, dirt and other foreign objects. In particular the lid and rim should close sufficiently to prevent ingress of small insects and the like. A maximum opening of 70 microns in the closed state is generally considered sufficient to achieve this. It will be understood that any connection between the container and the rim should also be closed to the same tolerance or better.

It will be understood that the scoop tray may be a shallow shelf or closed form into which the scoop may be placed horizontally Preferably however, at least part of an underside of the scoop recess comprises an aperture to an interior of the container, whereby the scoop seals the aperture in the scoop recess. An advantage of the aperture in the underside of the scoop recess is that powder falling from the scoop will not collect in the recess but will instead fall back into the container. By sealing the aperture in the scoop recess by the scoop, entry of the powder into the recess from the container during storage e.g. prior to first opening is prevented.

Preferably, the scoop and the scoop recess are formed complementary to each other for accommodating the scoop in the recess during storage, such that the aperture in the scoop recess to the interior of the container is sealed by the complementary shaped scoop. As the scoop and the scoop recess have complementary shapes, the scoop may be well-fitted into the recess, thereby improving sealing of the aperture in the scoop recess.

According to one preferred embodiment the scoop comprises a cup and the recess comprises a bowl portion shaped complementary to the cup, whereby the aperture in the recess is located at the bowl portion, such that the cup is accommodated in the aperture, thereby sealing the aperture. Prior to use, the scoop may be held tightly against the recess by the foil, ensuring that the aperture remains closed. The aperture or the scoop may be provided with additional sealing provisions such as ridges or edges that engage to improve sealing of the aperture.

The scoop recess may also be provided with further regions to allow a user to easily grasp the scoop for removal from the recess and it may be provided with retention elements to grip the scoop or otherwise prevent it from being accidentally dislodged from the recess. Preferably, such retention elements comprise funnel-like sides to the recess, extending towards the base of the container and a conical shaped cup, whereby the cup of the scoop is accommodated in the recess and whereby a bottom part of the scoop cup seals the aperture located at a base part of the recess. The conical shaped cup and the funnel-like sides of the recess are closely fitted when the cup is accommodated in the recess. The cup then closes the aperture of the recess and simultaneously forms the base of the recess. In this context, it is understood that the conical shape of the cup refers to the portion of the sides of the cup engaging with the recess. The recess and the cup may have a conicity of less than 10 degrees, preferably between 4 degrees and 7 degrees to ensure good retention. The skilled person will be well aware of how to choose this angle in order to achieve the desired retention and closure, depending upon the given materials used.

In one embodiment, the powder compartment is sealed by a first foil and the scoop tray is sealed by a second foil, whereby the first and second foils are separately removable prior to use. By using separate foils for respectively sealing the scoop tray and the powder compartment, sealing of each compartment may be carried out independently. In a preferred embodiment however, the container and the scoop tray are sealed by a single foil, allowing sealing and opening to take place in a single action.

Preferably, the container has a width dimension and a length dimension and at least the length dimension is greater than the depth dimension. Such a low profile container ensures that a user can easily reach with the scoop to the bottom of the container to extract the last of the product. The package may also be dimensioned such that the recess has a length that is substantially equal to the depth dimension. It is then possible to provide a scoop, contained in the recess, which is at least almost as long as the container is deep without having to place it diagonally or lengthwise across the access opening. The invention is particularly advantageous for such low profile containers since it allows reduced head space for accommodation of the scoop, since the scoop no longer has to be located above the level of the powdered content or foil. In fact, depending upon the process of filling, the scoop may even be located at a level lower than that of the powder.

Preferably, the container has a generally square or rectangular outer profile with rounded corners. The access opening may also be generally of a similar shape. The recess may be located within and accessible through the access opening although it will be understood that a scoop opening alongside the access opening may be provided.

The scoop tray may be integrally formed with the container. Preferably however, the scoop tray will be formed separately from and connectable to the container. This may have advantages in that different sized recesses may be provided and the scoop tray may be attached at either a right side or a left side of the container for left- or right-handed use. The scoop tray may be attached by any suitable means to the container, including adhesives or by form fit. In one preferred arrangement, the scoop tray is engaged by lugs adjacent to a top edge of the container.

Depending upon the manner in which the package is constructed the foil may be arranged in various different configurations. In one configuration, the foil may be connected to an inner surface of the peripheral wall, at a distance from the top edge of the container. Such an arrangement is especially convenient for carton or paperboard containers having a heat-sealable inner surface. Such carton laminates have been extensively employed for food packaging and in particular for infant formula such as described in the earlier mentioned WO2010071424. Preferable laminates comprise a layer of a relatively thin aluminium foil sandwiched between an outer carton/cardboard layer and an inner polymeric layer. The outer carton layer provides a good base for printing and an agreeable texture; the aluminium foil layer ensures excellent barrier properties for long term storage; the inner polymeric layer should be of food quality and may serve as a heat-sealable surface for connection to the foil seal.

In an alternative preferred configuration, the foil may be sealed across the top edge of the container. Such an arrangement is convenient for containers having a flange at the top of the peripheral wall, in particular for thermoformed or blow moulded polymer containers. Any suitable plastics material may be employed for the container including polypropelene (PP), polycarbonate (PC), polyethylene (PE), polyvinylidene chloride (PVC), polyamide (PA) and mixtures or combinations thereof. In a particular preferred embodiment, the container is formed of a laminate of polypropelene having an internal barrier layer of e.g. ethylene vinyl alcohol (EVOH) material. The container may also be a composite construction comprising an inner thin thermoformed or vacuum formed polymer container supported by a carton based sleeve. In another alternative configuration, the foil may be sealed to the rim. The rim or the seal may in turn be sealed to the container. In cases where a single foil is used, sealed to a rim of the container, the scoop tray is preferably coextensive with the rim in order that the foil can seal against both the tray and the rim together.

Preferably, the lid assembly, i.e. the rim and the lid, is injection moulded plastic. Any suitable plastics material may be employed including polypropylene (PP), polycarbonate (PC), polyethylene (PE), polyvinylidene chloride (PVC), polyamide (PA) and mixtures or combinations thereof. Preferably the lid part is manufactured from polypropylene. More preferably, the lid assembly is manufactured by dual injection moulding using a mixture of relatively soft and relatively hard plastic, e.g. polypropylene, for parts of the rim and lid, according to the function that they are required to perform e.g. sealing, rigidity, support. The hinged connection may be formed as a living hinge. An alternative two piece construction may also be envisaged. In addition, both the scoop tray and the scoop are preferably made of injection moulded plastic, e.g. polypropylene.

The seal may also be manufactured from conventional materials, including plastics and metals such as aluminium. It is preferred that the sealing foil is manufactured of mainly polypropylene. The foil may comprise a first polypropylene layer and a second polypropylene layer, with an ethylene vinyl alcohol (EVOH) barrier layer in between. By using the same material for the different parts, the recyclability of the package is increased, which is advantageous for the environment.

In a preferred embodiment of the invention, the seal is rupturable or frangible and may comprise a weakened tear line and a pull tab. In this manner, the seal may be removed without necessarily disrupting the connection between the seal and the container or rim. An edge of the seal may thus remain permanently connected to the container or rim. This is particularly convenient in cases where this edge remains sandwiched between the container and the rim.

In a further preferred embodiment of the invention, the lid or the rim are provided with tamper evident closure indication. This may be provided in the manner of a pull-tab that can be removed on first use. Additional child resistant closures may be provided as required in order to avoid accidental opening by an infant.

In a still further preferred embodiment, the package comprises stacking provisions on the base of the container and complementary provisions on the lid or rim such that a number of like containers can be stacked on one another in a stable manner. Such provisions may comprise ridges, grooves, protrusions, flanges and the like which serve to locate one container with respect to another, in particular by preventing relative lateral movement. In particular, the base of the container may be hollow having a downwardly extending peripheral flange

The invention also encompasses a package as described above including a quantity of powdered nutritional product sealed within the container. It will be understood that in this context powdered nutritional product can include powders, granules, pellets and the like and that nutritional product may be given its broadest possible meaning. Nevertheless, the invention is most specifically directed to baby or infant nutritional products such as milk formula.

According to a still further aspect of the invention there is also disclosed a method of manufacturing a package for a powdered nutritional product comprising providing a container defining a powder compartment for receiving a nutritional product, the container having a base and a peripheral wall, and a scoop tray defining a scoop recess for storing an elongate scoop, providing a circumferential rim defining a wide access opening and a lid, hingedly attached to the rim for reclosing the access opening.

The method further comprises filling the powder compartment with the product, placing a scoop in the scoop recess, sealing the product within the powder compartment by means of at least one foil sealed to the peripheral wall and covering the powder compartment and the scoop tray, and connecting the rim to the container.

In one particular form the method comprises providing a first foil for sealing the powder compartment, and a second foil for sealing the scoop tray. The scoop tray may then be sealed separately and may also be connected to the container in its sealed condition either before or after filling of the powder compartment. The first foil and second foil may be separately removed upon first use.

Preferably, the access opening has a minor dimension and a major dimension, whereby the method comprises providing the scoop tray at one side of the access opening, such that the scoop recess extends substantially across the minor dimension of the access opening. According to another embodiment, the method comprises connecting the recess to the top edge of the container.

### BRIEF DESCRIPTION OF THE DRAWINGS

The features and advantages of the invention will be appreciated upon reference to the following drawings of a number of exemplary embodiments, in which:

FIG. 1 shows a perspective view of a package according to a first embodiment of the present invention;

FIG. 2 is an exploded perspective view of the package of FIG. 1;

FIG. 3 is a partial cut-away view of the package of FIG. 1;

FIG. 4 is a cross-section of the package of FIG. 1, taken along line 2-2;

FIG. 5 shows a cross-section of a package according to a second embodiment of the invention;

FIG. 6 shows a cross-section of a package according to a third embodiment of the invention;

FIG. 7 is a plan view of the package of FIG. 1; and

FIG. 8 is a plan view of an alternative package according to the invention.

### DESCRIPTION OF ILLUSTRATIVE EMBODIMENTS

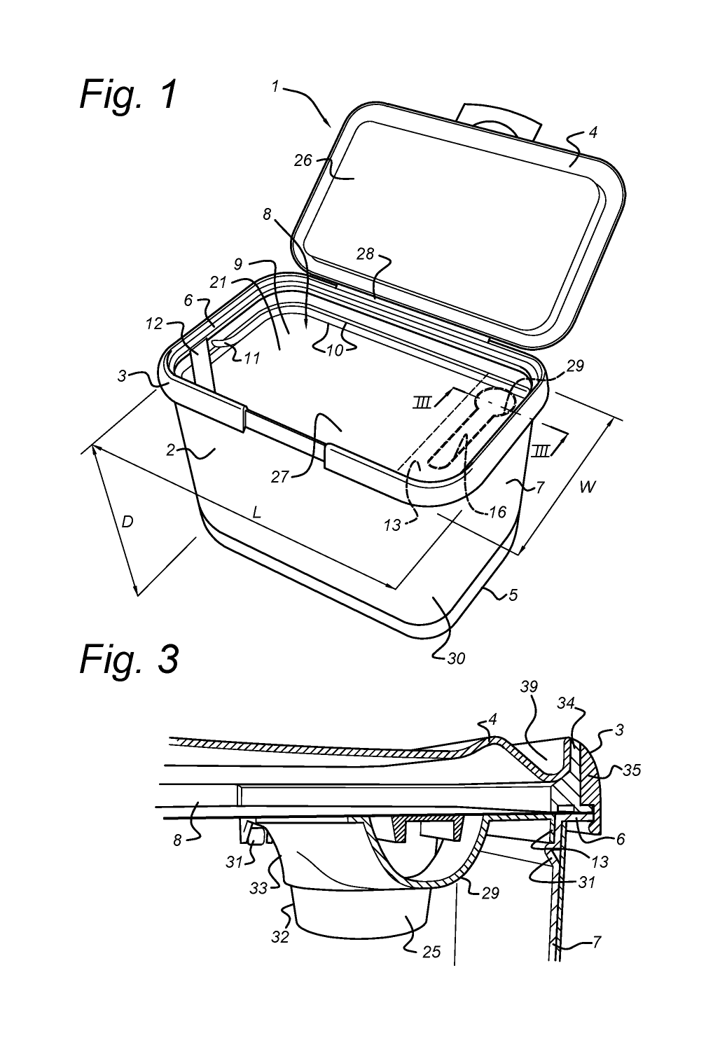

FIG. 1 shows a perspective view of a package 1 according to a first embodiment of the invention comprising a container 2 a scoop tray 13 and a lid assembly 26. The container has a base 5 and a peripheral wall 7 extending to a top edge 6 and defines a powder compartment 27. A carton sleeve 30 surrounds the peripheral wall 7. The scoop tray 13 is arranged within the container and defines a scoop recess 29. The lid assembly 26 comprises a circumferential rim 3 and a lid 4 for reclosing the container 2 after opening. The lid 3 and the rim 4 are formed as a single piece of plastic by injection moulding and are connected to one another by a living hinge 28 along one mutual side. The container 2 has a depth dimension D, measured from its base 5 to a top edge 6 of its peripheral wall 7. It also has a width dimension W and a length dimension L. A scoop 16 can be seen within the recess 29.

The rim 3 forms an access opening 8 providing access to the interior of the container 2. Within the access opening 8 there is provided a foil 9 having a tear line 10, a pull-tab 11 and an opening region 21. The foil 9 is connected to the top edge 6 of the peripheral wall 7 by heat-sealing. At one corner of the access opening 8 there is provided a leveller 12 which can be used to level-off the scoop 16 during use. The foil 9 seals the powder compartment 27 and the scoop tray 16 from the environment and from each other prior to use.

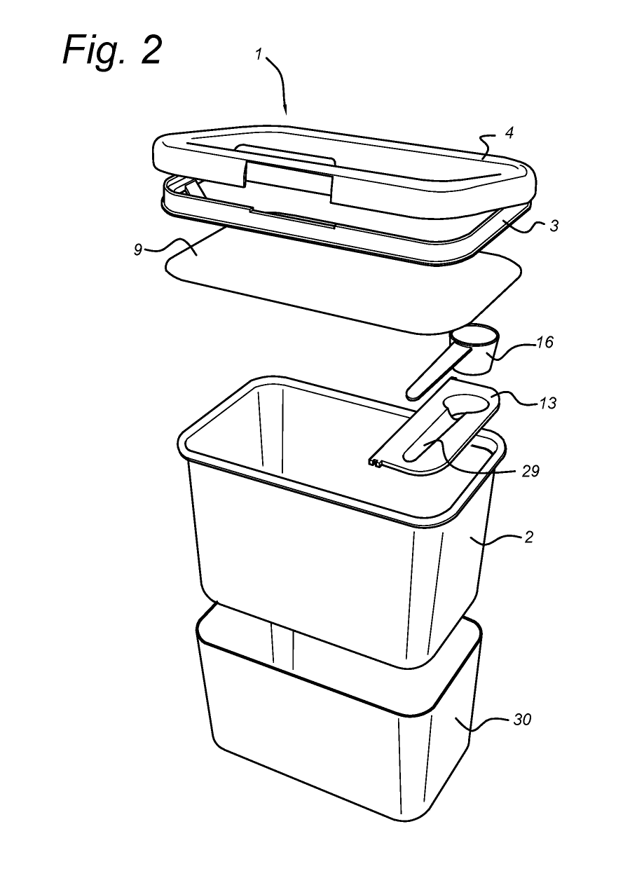

FIG. 2 shows the package 1 of FIG. 1 in exploded perspective view, clearly showing the lid 4, rim 3, foil 9, scoop 16, scoop tray 13, container 2 and sleeve 30. As can be better appreciated in this view, the recess 29 in the scoop tray 13 is generally complementary to the shape of the scoop 16

FIG. 3 shows a cutaway perspective view through part of the package 1 of FIG. 1 showing the scoop recess 29 and the connection of the scoop tray 13 to the container 2. Close to the top edge 6 of the container 2, the peripheral wall 7 is provided with lugs 31 which engage and support the scoop tray 13. The lugs 31 may be formed during a thermoforming procedure for manufacturing the container 2. Also visible in this view is a conical shaped portion 32 of the cup 25 of the scoop 16 and corresponding funnel shaped sides 33 of the scoop recess 29.

As may also be seen in FIG. 3, the rim 3 is formed of two different components. An inner rim 34 is formed of hard polypropylene, while an outer rim 35 is formed of relatively softer polypropylene. Both portions may be injection moulded together in a dual injection moulding process together with the lid 4, which is also formed of the softer material. As a result of this construction, the respective portions are better adapted to fit and seal together. Thus outer rim 35 can engage and grip top edge 6 of the container 2 and lid 4 can better seal within the inner rim 34 on closing the access opening 8. The lid 4 is provided with a channel 39 around its periphery serving as part of a complementary stacking arrangement, co-operating with a corresponding shape at the base 5 of the container.

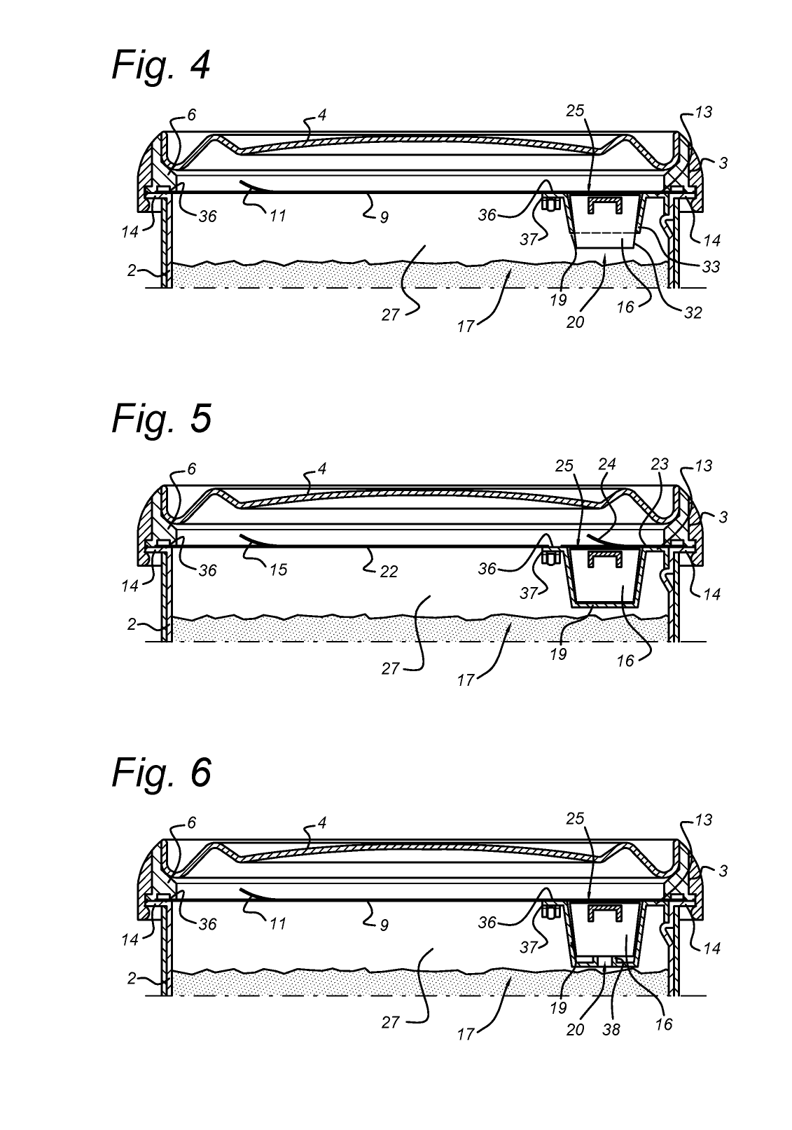

FIG. 4 shows a partial cross-section through the package of FIG. 1 taken along line 2-2. The container 2 is formed by thermoforming and has an outwardly directed annular flange 14 at the top edge 6 of the container 2. The scoop tray 13 is separately provided and connected to the annular flange 14. The foil 9 covers the recess 13 whereby the contents 17 of the container and the scoop 16 are sealed from each other within the container 2 prior to removal of the foil 9. Also as may be seen in FIG. 4, the underside 19 of the recess 29 has an aperture 20 covering the whole of the recess underside 19. The recess 29 has funnel-shaped sides 33, whereby the base of the recess 29 is formed by the aperture 20. The cup 25 has a conical shaped portion 32 engaged within the funnel shaped sides 33. The foil 9 is sealed to the annular flange 14 and to the scoop tray 13 at seal 36. In particular seal 36 is provided at a separating edge 37 demarcating the scoop tray 13 from the powder compartment 27.

In use, and with reference to FIGS. 1 to 4, the package 1 is opened by hinging back the lid 4 to reveal the access opening 8. The pull-tab 11 may then be grasped in order to rupture the foil 9 along the line of weakness 10 exposing the powder 17. The scoop 16 is initially located in the recess 29 and may be removed to perform dosing of the powder 17. After use it is returned to the recess 29 and the lid 4 is closed. In the illustrated embodiment, the container has a depth D of 150 mm, a length L of 190 mm and a width W of 127 mm. The amount of milk powder contained in the container 2 is around 800 gram.

FIG. 5 shows a view of a second embodiment of the invention in a similar cross-sectional view to that of FIG. 4. In this embodiment, a first foil 22 covers the access opening 8, sealing the powdered content 17 into the container. A second foil 23 covers the scoop tray 13 whereby the scoop 16 is sealed within the recess 29 prior to removal of the foil 23. The first foil 22 can be ruptured by pull-tab 15 to gain access to the contents of the package. The second foil 23 can be ruptured by a second pull-tab 24 prior to use to be able to use the scoop 16 for dosing the powdered content 17 of the package 1. As can be seen in FIG. 5, the underside 19 of the scoop recess 29 is closed, such that the powdered content 17 is prevented from ingress into the scoop recess 29.

FIG. 6 shows a view of a third embodiment of the invention in a similar cross-sectional view to that of FIG. 4. In this embodiment, the recess 29 is provided with a round aperture 20 in its base 19 surrounded by a ridge 38. The scoop 16 has a cup 25 having a corresponding shape which engages with the ridge 38 to seal the aperture 20. A foil 9 covers the powder compartment 27 and the scoop tray 13 and is sealed to both at seal 36. The foil 9 also exerts a slight tension on the scoop 16, forcing it downwards such that the cup 25 maintains close contact with the ridge 38.

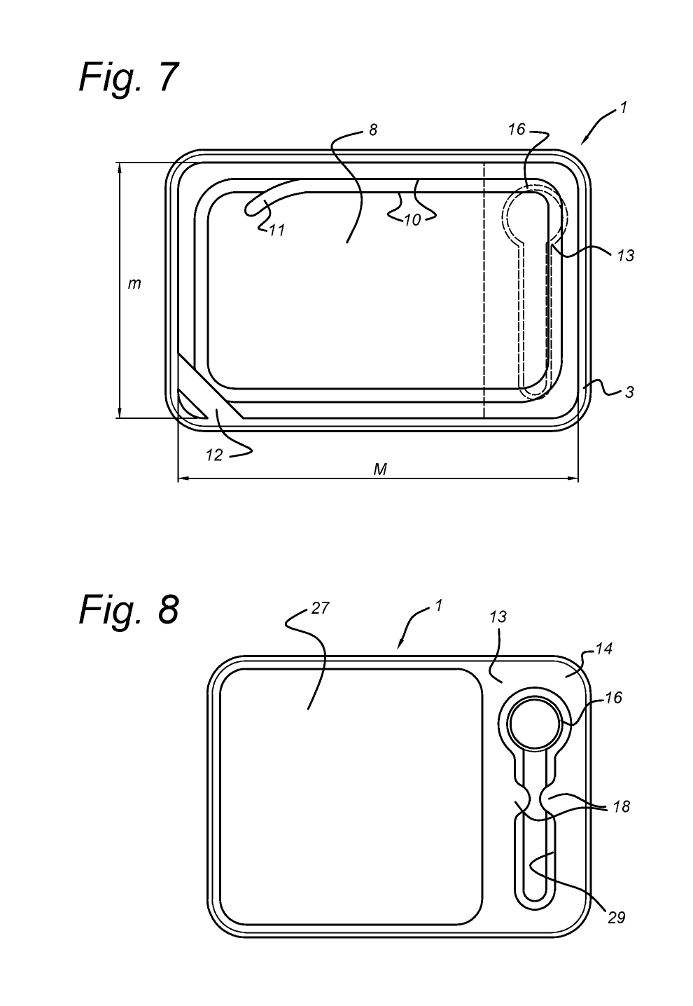

FIG. 7 is a plan view of the package 1 of FIG. 2 with the lid removed for the sake of clarity. Rim 3 surrounds access opening 8 which has a major dimension M and a minor dimension m. The recess 29 is located at one side of the opening 8 and aligned across the minor dimension m or width W of the container 2. The scoop 16 has almost the same length as the opening 8 is wide.

FIG. 8 shows a plan view of an alternative form of package 1 having a substantially square cross section. For the sake of clarity, lid, rim and foil have all been removed. Annular flange 14 surrounds the powder compartment 27 and scoop tray 13, which in this embodiment are integrally formed together. Retention elements 18 are provided within the recess 29 to engage the scoop 16 and prevent it from being dislodged.

Thus, the invention has been described by reference to certain embodiments discussed above. It will be recognized that these embodiments are susceptible to various modifications and alternative forms well known to those of skill in the art.

Many modifications in addition to those described above may be made to the structures and techniques described herein without departing from the spirit and scope of the invention. Accordingly, although specific embodiments have been described, these are examples only and are not limiting upon the scope of the invention.

### LIST OF PARTS

```
  1. Package
  2. Container
  3. Rim
  4. Lid
  5. Base
  6. Top edge
  7. Peripheral wall
  8. Access opening
  9. Foil
10. Tear line
11. Pull-tab
12. Leveler
13. Scoop tray
14. Annular flange
15. First pull-tab
16. Scoop
17. Powdered contents
18. Retention elements
19. Recess base
20. Recess aperture
21. Opening region
22. First foil
23. Second foil
24. Second pull tab
25. Cup
26. Lid assembly
27. Powder compartment
28. Living hinge
29. Scoop recess
30. Sleeve
31. Lugs
32. Conical-shaped portion
33. Funnel-shaped sides
34. Inner rim
35. Outer rim
36. Seal
37. Separating edge
38. Ridge
39. Channel
```

1-27. (canceled)

28. A package for a powdered nutritional product comprising:
a container defining a powder compartment for receiving the nutritional product, the container having a base and a peripheral wall;
a circumferential rim for connection to the container and defining a wide access opening;
a scoop tray defining a scoop recess for storing an elongate scoop,
a scoop contained in the recess;
a lid, hingedly attached to the rim for reclosing the access opening and covering the scoop tray; and
at least one foil arranged to seal the container prior to use by independently sealing the powder compartment and the scoop tray.

29. Package according to claim 28, whereby at least part of an underside of the scoop recess comprises an aperture to the powder compartment allowing powder residue on the scoop to fall back into the powder compartment, whereby the scoop seals the aperture prior to use.

30. Package according to claim 29, whereby the scoop and the scoop recess are formed complementary to one another for accommodating the scoop in the recess during storage, such that the aperture in the scoop recess to the interior of the container is sealed by the complementary shaped scoop.

31. Package according to claim 29, whereby the scoop comprises a cup and the recess comprises a bowl portion shaped complementary to the cup, whereby the aperture in the recess is located at the bowl portion, such that the cup is accommodated in the aperture, thereby sealing the aperture.

32. Package according to claim 28, wherein the recess has retention elements to prevent a scoop being dislodged from the recess.

33. Package according to claim 32, whereby the retention elements comprise funnel-like sides to the recess, extending towards the base of the container and a conical shaped cup part of the scoop, whereby the cup is engaged by the funnel-like sides.

34. Package according to claim 28, wherein the at least one foil is connected to an inner surface of the peripheral wall, at a distance from a top edge of the container, thereby sealing the scoop tray and the powder compartment.

35. Package according to claim 28, wherein the at least one foil is sealed across a top edge of the container, thereby sealing the scoop tray and the powder compartment.

36. Package according to claim 28, wherein the at least one foil is sealed to the rim, thereby sealing the scoop tray and the access opening.

37. Package according to claim 28, whereby the scoop tray is connected to the rim.

38. Package according to claim 28, whereby the powder compartment is sealed by a first foil and the scoop tray is sealed by a second foil, whereby the first and second foils are separately removable prior to use.

39. Package according to claim 28, whereby the tray is provided at one side of the access opening.

40. Package according to claim 39, whereby the access opening has a minor dimension and a major dimension and whereby the recess has a length that is at least substantially equal to the minor dimension of the access opening.

41. Package according to claim 28, wherein the at least one foil comprises a weakened tear line and a pull tab.

42. Package according to claim 28, wherein the rim and the lid are integrally formed of polymeric material.

43. Package according to claim 28, wherein the container comprises an inner portion thermoformed from a polymeric material supported by a carton based outer sleeve.

44. The package according to claim 28, wherein the scoop tray is separately formed from and connectable to the top edge of the container.

45. Package according to claim 28, wherein the lid or the rim are provided with tamper evident closure indication.

46. Package according to claim 28, wherein the scoop has a length that is substantially equal to a depth dimension of the container.

47. Package according to claim 28, further comprising a quantity of powdered infant formula sealed within the container.

48. A package for a powdered nutritional product comprising:
a container defining a powder compartment for receiving the nutritional product, the container having a base and a peripheral wall and being attachable to a circumferential rim defining a wide access opening and having a lid, hingedly attached to the rim for reclosing the access opening;
a scoop tray defining a scoop recess for storing an elongate scoop,
a scoop contained in the recess; and
at least one foil arranged to seal across a top edge of the container prior to use by independently sealing the powder compartment and the scoop tray, wherein the container is a composite construction comprising an inner thin thermoformed polymer container supported by a carton based sleeve.
